(19) United States
(12) Patent Application Publication
(10) Pub. No.: US 2003/0211413 A1
(43) Pub. Date: Nov. 13, 2003

(54) Imaging members

(75) Inventors: Liang-Bin Lin, Webster, NY (US); Andronique Ioannidis, Webster, NY (US); Ah-Mee Hor, Mississauga (CA); Harold F. Hammond, Webster, NY (US); Anderw R. Melnyk, Rochester, NY (US); James M. Markovics, Rochester, NY (US); James M. Duff, Mississauga (CA); Timothy P. Bender, Port Credit (CA); Richard H. Nealey, Penfield, NY (US); Cindy C. Chen, Rochester, NY (US); Linda L. Ferrarese, Rochester, NY (US); Kenny-Tuan T. Dinh, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation.

(21) Appl. No.: 10/144,147

(22) Filed: May 10, 2002

(51) Int. Cl. G03G 5/06

(52) U.S. Cl. 430/78; 430/56; 430/83; 430/72; 430/75; 430/96

(57) ABSTRACT

A photoconductive imaging member comprised of a supporting substrate, and thereover a single layer comprised of a mixture of a photogenerator component, a charge transport component, an electron transport component, and a polymer binder, and wherein the photogenerating component is a pigment.

### RELATED PATENT APPLICATIONS

Illustrated in copending application U.S. Ser. No. 09/302,524, the disclosure of which is totally incorporated herein by reference, is, for example, an ambipolar photoconductive imaging member comprised of a supporting substrate, and thereover a layer comprised of a photogenerator hydroxygallium component, a charge transport component, and an electron transport component.

Illustrated in copending application U.S. Ser. No. 09/627,283, the disclosure of which is totally incorporated herein by reference, is, for example, an imaging member comprising

a supporting layer and

an electrophotographic photoconductive insulating layer, the electrophotographic photoconductive insulating layer comprising

particles comprising Type V hydroxygallium phthalocyanine dispersed in a matrix comprising

an arylamine hole transporter, and

an electron transporter selected from the group consisting of

N,N′-bis(1,2-dimethylpropyl)-1,4,5,8-naphthalenetetracarboxylic diimide represented by the following structural formula

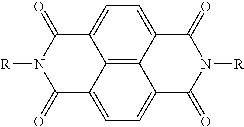

1,1′-dioxo-2-(4-methylphenyl)-6-phenyl-4-(dicyanomethylidene)thiopyran represented by the following structural formula

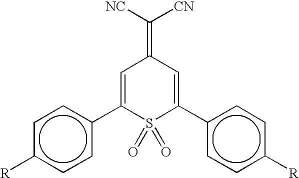

wherein each R is independently selected from the group consisting of hydrogen, alkyl having 1 to 4 carbon atoms, alkoxy having 1 to 4 carbon atoms and halogen, and

a quinone selected from the group consisting of

carboxybenzylnaphthaquinone represented by the following structural formula

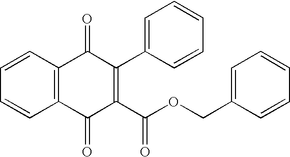

and ter(t-butyl) diphenolquinone represented by the following structural formula

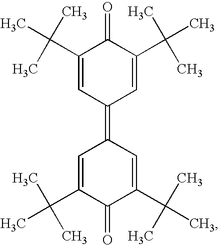

and

mixtures thereof, and a film forming binder.

The appropriate components and processes of the above copending applications may be selected for the invention of the present application in embodiments thereof.

### BACKGROUND

This invention relates in general to electrophotographic imaging members and, more specifically, to positively and negatively charged electrophotographic imaging members having a single electrophotographic photoconductive insulating layer and processes for forming images on the member. More specifically, the present invention relates to a singled layered photoconductive imaging member containing a charge generation layer or photogenerating layer comprised of a metal free phthalocyanine component dispersed in a matrix of a hole transporting and an electron transporting binder, and in embodiments as a second or top layer a charge, especially hole transport layer. The electrophotographic imaging member layer components, which can be dispersed in various suitable resin binders, can be of various thickness, however, in embodiments a thick layer, such as from about 5 to about 60, and more specifically from about 10 to about 40 microns, is selected. This layer can be considered a dual function layer since it can generate charge and transport charge over a wide distance, such as a distance of at least about 50 microns. Also, the presence of the electron transport components in the photogenerating layer can enhance electron mobility and thus enable a thicker photogenerating layer, and which thick layers can be more easily coated than a thin layer, such as about 1 to 2 microns thick.

Many electrophotographic imaging members are multi-layered imaging members comprising a substrate and a plurality of other layers such as a charge generating layer and a charge transport layer. These commercial multi-layered imaging members also often contain a charge blocking layer and an adhesive layer between the substrate and the charge generating layer. Further, an anti-plywooding layer may be needed. This anti-plywooding layer can be a separate layer or be part of a dual function layer. An example of a dual function layer for preventing plywooding is a charge blocking layer or an adhesive layer which also prevents plywooding. The expression “plywooding”, as employed herein, refers in embodiments to the formation of unwanted patterns in electrostatic latent images caused by multiple reflections during laser exposure of a charged imaging member. When developed, these patterns resemble plywood. These multi-layered imaging members are also costly and time consuming to fabricate because of the many layers that must be formed. Further, complex equipment and valuable factory floor space are required to manufacture these multi-layered imaging members. In addition to presenting plywooding problems, the multi-layered imaging members often encounter charge spreading which degrades image resolution.

Another problem encountered with multilayered photoreceptors comprising a charge generating layer and a charge transport layer is that the thickness of the charge transport layer, which is normally the outermost layer, tends to become thinner due to wear during image cycling. The change in thickness causes changes in the photoelectrical properties of the photoreceptor. Thus, to maintain image quality, complex and sophisticated electronic equipment and software management are usually necessary in the imaging machine to compensate for the photoelectrical changes, which can increase the complexity of the machine, cost of the machine, size of the footprint occupied by the machine, and the like. Without proper compensation of the changing electrical properties of the photoreceptor during cycling, the quality of the images formed can degrade because of spreading of the charge pattern on the surface of the imaging member and a decline in image resolution. High quality images can be important for digital copiers, duplicators, printers, and facsimile machines, particularly laser exposure machines that demand high resolution images. Moreover, the use of lasers to expose conventional multilayered photoreceptors can lead to the formation of undesirable plywood patterns that are visible in the final images.

Attempts have been made to fabricate electrophotographic imaging members comprising a substrate and a single electrophotographic photoconductive insulating layer in place of a plurality of layers such as a charge generating layer and a charge transport layer. However, in formulating single electrophotographic photoconductive insulating layer photoreceptors many problems need to be overcome including charge acceptance for hole and/or electron transporting materials from photoelectroactive pigments. In addition to electrical compatibility and performance, a material mix for forming a single layer photoreceptor should possess the proper rheology and resistance to agglomeration to enable acceptable coatings. Also, compatibility among pigment, hole and electron transport molecules, and film forming binder is desirable. As utilized herein, the expression “single electrophotographic photoconductive insulating layer” refers in embodiments to a single electrophotographically active photogenerating layer capable of retaining an electrostatic charge in the dark during electrostatic charging, imagewise exposure and image development. Thus, unlike a single electrophotographic photoconductive insulating layer photoreceptor, a multi-layered photoreceptor has at least two electrophotographically active layers, namely at least one charge generating layer and at least one separate charge transport layer.

### PRIOR ART

U.S. Pat. No. 4,265,990 discloses a photosensitive member having at least two electrically operative layers. The first layer comprises a photoconductive layer which is capable of photogenerating holes and injecting photogenerated holes into a contiguous charge transport layer. The charge transport layer comprises a polycarbonate resin containing from about 25 to about 75 percent by weight of one or more of a compound having a specified general formula. This structure may be imaged in the conventional xerographic mode which usually includes charging, exposure to light and development.

U.S. Pat. No. 5,336,577 disclosing a thick organic ambipolar layer on a photoresponsive device is simultaneously capable of charge generation and charge transport. In particular, the organic photoresponsive layer contains an electron transport material such as a fluorenylidene malonitrile derivative and a hole transport material such as a dihydroxy tetraphenyl benzadine containing polymer. These may be complexed to provide photoresponsivity, and/or a photoresponsive pigment or dye may also be included.

The entire disclosures of these patents are incorporated herein by reference.

### SUMMARY

It is, therefore, a feature of the present invention to provide electrophotographic imaging members comprising a single electrophotographic photoconductive insulating layer.

It is another feature of the present invention to provide an improved electrophotographic imaging member comprised of a single electrophotographic photoconductive insulating layer that avoids plywooding problems, and which layer contains a photogenerating pigment, an electron transport component, a hole transport component, and a filming forming binder.

It is still another feature of the present invention to provide an improved electrophotographic imaging member comprising a single electrophotographic photoconductive insulating layer that eliminates the need for a charge blocking layer between a supporting substrate and an electrophotographic photoconductive insulating layer, and wherein the photogenerating mixture layer can be of a thickness of, for example, from about 5 to about 60 microns, and thereover as the top layer a charge transporting layer, and which members possess excellent high photosensitivities, acceptable discharge characteristics, and further which members are visible and infrared laser compatible.

It is yet another feature of the present invention to provide an electrophotographic imaging member comprising a single electrophotographic photoconductive insulating layer which can be fabricated with fewer coating steps at reduced cost.

It is another feature of the present invention to provide an electrophotographic imaging member comprising a single electrophotographic photoconductive insulating layer which eliminates charge spreading, therefore, enabling higher resolution, and which members are not substantially susceptible to plywooding effects, a light refraction problem, and thus with the photoconductive imaging members of the present invention in embodiments thereof an undercoated separate layer is avoided.

It is yet another feature of the present invention to provide an improved electrophotographic imaging member comprising a single electrophotographic photoconductive insulating layer which has improved cycling and stability, and which members possess high resolution since, for example, the image forming charge packet does not need to traverse the entire thickness of the member and thus does not spread in area, and further with such singled layered members there is enabled in embodiments extended life high resolution members since, for example, the layer can be present in a thicker, such as from 5 to about 60 microns, layer as compared to a number of multilayered devices wherein the thickness of the photogenerator layer is usually about 1 to about 3 microns in thickness, thus with the aforementioned invention devices there is substantially no image resolution loss and substantially no image resolution loss with wear.

It yet another feature of the present invention to provide an at improved electrophotographic imaging member comprising a single electrophotographic photoconductive insulating layer for which PIDC curves do not substantially change with time or repeated use, and also wherein with these photoreceptors charge injections from the substrate to the photogenerating pigment is reduced and thus a charge blocking layer can be avoided.

It still another feature of the present invention to provide an improved electrophotographic imaging member comprising a single electrophotographic photoconductive insulating layer which is ambipolar and can be operated at either positive (the preferred mode) or negative biases.

The present invention in embodiments thereof is directed to a photoconductive imaging member comprised of a supporting substrate, a single layer thereover comprised of a mixture of a photogenerating pigment or pigments, a hole transport component or components, an electron transport component or components, and a film forming binder. More specifically, the present invention relates to an imaging member with a thick, such as for example, from about 5 to about 60 microns, single active layer comprised of a mixture of photogenerating pigments, hole transport molecules, electron transport compounds, and a filming binder.

Aspects of the present invention are directed to a photoconductive imaging member comprised in sequence of a substrate, a single electrophotographic photoconductive insulating layer, the electrophotographic photoconductive insulating layer comprising photogenerating particles comprising photogenerating pigments, such as metal free phthalocyanines, dispersed in a matrix comprising a hole transport molecule such as, for example, those selected from the group consisting of an arylamine and a hydrazone, and an electron transport material, for example, selected from the group consisting of N,N′-bis(1,2-dimethylpropyl)-1,4,5,8-naphthalenetetracarboxylic diimide represented by the following formula

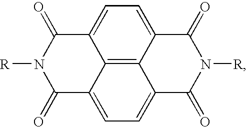

1,1′-dioxo-2-(4-methylphenyl)-6-phenyl-4-(dicyanomethylidene) thiopyran represented by the following formula

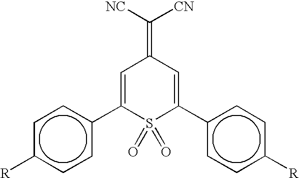

wherein R and R are independently selected from the group consisting of hydrogen, alkyl having 1 to 4 carbon atoms, alkoxy having 1 to 4 carbon atoms and halogen, and an optional quinone selected, for example, from the group consisting of carboxybenzylnaphthaquinone represented by the following formula

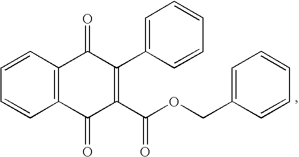

and

tetra(t-butyl) diphenolquinone represented by the following formula

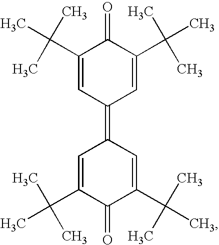

and

mixtures thereof, and a film forming binder, for example, selected from the group consisting of polycarbonates, polyesters, polystyrenes, and the like.

This imaging member may be imaged by depositing a uniform electrostatic charge on the imaging member, exposing the imaging member to activating radiation in image configuration to form an electrostatic latent image, and developing the latent image with electrostatically attractable marking particles to form a toner image in conformance to the latent image.

Any suitable substrate may be employed in the imaging member of this invention. The substrate may be opaque or substantially transparent, and may comprise any suitable material having the requisite mechanical properties. Thus, for example, the substrate may comprise a layer of insulating material including inorganic or organic polymeric materials, such as MYLAR® a commercially available polymer, MYLAR® coated titanium, a layer of an organic or inorganic material having a semiconductive surface layer, such as indium tin oxide, aluminum, titanium and the like, or exclusively be comprised of a conductive material such as aluminum, chromium, nickel, brass and the like. The substrate may be flexible, seamless or rigid and may have a number of many different configurations, such as, for example, a plate, a drum, a scroll, an endless flexible belt, and the like. In one embodiment, the substrate is in the form of a seamless flexible belt. The back of the substrate, particularly when the substrate is a flexible organic polymeric material, may optionally be coated with a conventional anticurl layer. Examples of substrate layers selected for the imaging members of the present invention can be as indicated herein, such as an opaque or substantially transparent material, and may comprise any suitable material having the requisite mechanical properties. Thus, the substrate may comprise a layer of insulating material including inorganic or organic polymeric materials, such as MYLAR® a commercially available polymer, MYLAR® containing titanium, or other suitable metal, a layer of an organic or inorganic material having a semiconductive surface layer, such as indium tin oxide, or aluminum arranged thereon, or a conductive material inclusive of aluminum, chromium, nickel, brass or the like. The thickness of the substrate layer as indicated herein depends on many factors, including economical considerations, thus this layer may be of substantial thickness, for example over 3,000 microns, or of a minimum thickness. In one embodiment, the thickness of this layer is from about 75 microns to about 300 microns.

Generally, the thickness of the single layer in contact with the supporting substrate depends on a number of factors, including the thickness of the substrate, and the amount of components contained in the single layer, and the like. Accordingly, the layer can be of a thickness of, for example, from about 3 microns to about 60 microns, and more specifically, from about 5 microns to about 30 microns. The maximum thickness of the layer in an embodiment is dependent primarily upon factors, such as photosensitivity, electrical properties and mechanical considerations.

The binder resin present in various suitable amounts, for example from about 5 to about 70, and more specifically, from about 10 to about 50 weight percent, may be selected from a number of known polymers such as poly(vinyl butyral), poly(vinyl carbazole), polyesters, polycarbonates, poly(vinyl chloride), polyacrylates and methacrylates, copolymers of vinyl chloride and vinyl acetate, phenoxy resins, polyurethanes, poly(vinyl alcohol), polyacrylonitrile, polystyrene, and the like. In embodiments of the present invention, it is desirable to select as the single layer coating solvents, such as ketones, alcohols, aromatic hydrocarbons, halogenated aliphatic hydrocarbons, ethers, amines, amides, esters, and the like. Specific binder examples are cyclohexanone, acetone, methyl ethyl ketone, methanol, ethanol, butanol, amyl alcohol, toluene, xylene, chlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, and the like.

An optional adhesive layer may be formed on the substrate. Typical materials employed in an undercoat adhesive layer include, for example, polyesters, polyamides, poly(vinyl butyral), poly(vinyl alcohol), polyurethane and polyacrylonitrile, and the like. Typical polyesters include, for example, VITEL® PE100 and PE200 available from Goodyear Chemicals, and MOR-ESTER 49,000® available from Norton International. The undercoat layer may have any suitable thickness, for example, of from about 0.001 micrometer to about 10 micrometers. A thickness of from about 0.1 micrometer to about 3 micrometers can be desirable. Optionally, the undercoat layer may contain suitable amounts of additives, for example, of from about 1 weight percent to about 10 weight percent, of conductive or nonconductive particles, such as zinc oxide, titanium dioxide, silicon nitride, carbon black, and the like, to enhance, for example, electrical and optical properties. The undercoat layer can be coated on to a supporting substrate from a suitable solvent. Typical solvents include, for example, tetrahydrofuran, dichloromethane, and the like, and mixtures thereof.

Aspects of the present invention relate to a photoconductive imaging member comprised of supporting substrate, and thereover a layer comprised of a mixture of a metal free phthalocyanine photogenerator pigment, a hole transport component, and an electron transport component; a member wherein the single layer is of a thickness of from about 5 to about 60 microns; a member wherein the amounts for each of the components in the mixture is from about 0.05 weight percent to about 30 weight percent for the photogenerating component, from about 10 weight percent to about 75 weight percent for the hole transport component, and from about 10 weight percent to about 75 weight percent for the electron transport component, and wherein the total of the components is about 100 percent, and wherein the layer is dispersed in from about 10 weight percent to about 75 weight percent of a polymer binder; a member wherein the amounts for each of the components is from about 0.5 weight percent to about 5 weight percent for the photogenerating component; from about 30 weight percent to about 50 weight percent for the charge transport component; and from about 5 weight percent to about 30 weight percent for the electron transport component; and which components are contained in from about 30 weight percent to about 50 weight percent of a polymer binder; a member wherein the thickness of the single photogenerating layer mixture is from about 10 to about 40 microns; a member wherein the components are contained in a polymer binder and wherein the charge transport is comprised of hole transport molecules; a member wherein the binder is present in an amount of from about 40 to about 90 percent by weight and wherein the total of all components of photogenerating component, the hole transport component, the binder, and the electron transport component is about 100 percent; a member wherein the metal free phthalocyanine absorbs light of a wavelength of from about 550 to about 950 nanometers; an imaging member wherein the supporting substrate is comprised of a conductive substrate comprised of a metal; an imaging member wherein the conductive substrate is aluminum, aluminized polyethylene terephthalate or titanized polyethylene terephthalate; an imaging member wherein the binder for the single photogenerating mixture layer and for the top charge transport layer when present is selected from the group consisting of polyesters, polyvinyl butyrals, polycarbonates, polystyrene-b-polyvinyl pyridine, amines, such as N,N′-diphenyl-N,N′-bis(alkylphenyl)-1,1-biphenyl-4,4′-diamine; tri-p-tolylamine; N,N′-bis-(3,4,-dimethylphenyl)-4-biphenyl amine; N,N′-bis-(4-methylphenyl)-N,N″-bis(4-ethylphenyl)-1,1′-3,3′-dimethylbiphenyl)-4,4′-diamine; PHN, phenanthrene diamine; polyvinyl formulas; and the like; an imaging member wherein the hole transport in the photogenerating mixture and for the charge transport top layer when present comprises aryl amine molecules; an imaging member wherein the hole transport in the photogenerating mixture is comprised of

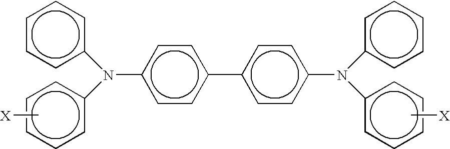

wherein X is selected from the group consisting of alkyl and halogen; an imaging member wherein alkyl contains from about 1 to about 10 carbon atoms, and wherein the top charge transport when present is an aryl amine encompassed by the formula and which amine is optionally dispersed in a highly insulating and transparent resinous binder; an imaging member wherein alkyl contains from 1 to about 5 carbon atoms; an imaging member wherein alkyl is methyl, and wherein halogen is chloride; an imaging member wherein the charge transport is comprised of N,N′-diphenyl-N,N-bis(3-methyl phenyl)-1,1′-biphenyl4,4′-diamine dispersed in a resin binder; an imaging member wherein the electron transport component is (4-n-butoxycarbonyl-9-fluorenylidene)malononitrile, 2-methylthioethyl 9-dicyanomethylenefluorene-4-carboxylate, 2-(3-thienyl)ethyl 9-dicyanomethylenefluorene-4-carboxylate, 2-phenylthioethyl 9-dicyanomethylenefluorene-4-carboxylate, 11,11,12,12-tetracyano anthraquinodimethane or 1,3-dimethyl-10-(dicyanomethylene)-anthrone; an imaging member wherein the electron transport component is (4-n-butoxycarbonyl-9-fluorenylidene)malononitrile; an imaging member wherein the electron transport component is (4-n-butoxycarbonyl-9-fluorenylidene)malononitrile, 2-methylthioethyl 9-dicyanomethylenefluorene-4-carboxylate, 2-(3-thienyl)ethyl 9-dicyanomethylenefluorene-4-carboxylate, 2-phenylthioethyl 9-dicyanomethylenefluorene-4-carboxylate, 11,11,12,12-tetracyanoanthraquino dimethane or 1,3-dim ethyl-10-(dicyanomethylene)-anthrone; an imaging member wherein the photogenerating component is a metal free phthalocyanine; an imaging member wherein the photogenerating component is a metal free phthalocyanine, the electron transport is (4-n-butoxy carbonyl-9-fluorenylidene)malononitrile, and the charge transport is a hole transport of N,N′-diphenyl-N,N-bis(3-methyl phenyl)-1,1′-biphenyl4,4′-diamine molecules; an imaging member wherein the X polymorph metal free phthalocyanine has major peaks, as measured with an X-ray diffractometer, at Bragg angles (2 theta±0.2°); an imaging member wherein the photogenerating component mixture layer further contains a second photogenerating pigment; an imaging member wherein the photogenerating mixture layer further contains a perylene; an imaging member wherein the photogenerating component is comprised of a mixture of a metal free phthalocyanine, and a second photogenerating pigment; a method of imaging which comprises generating an electrostatic latent image on the imaging member of the present invention, developing the latent image, and transferring the developed electrostatic image to a suitable substrate; a method of imaging wherein the imaging member is exposed to light of a wavelength of from about 500 to about 950 nanometers; an imaging apparatus containing a charging component, a development component, a transfer component, and a fixing component, and wherein the apparatus contains a photoconductive imaging member comprised of supporting substrate, and thereover a layer comprised of a metal free phthalocyanine photogenerator component, a charge transport component, and an electron transport component; a member wherein the electron transport is (4-n-butoxycarbonyl-9-fluorenylidene)malononitrile, 2-methylthioethyl 9-dicyano methylenefluorene-4-carboxylate, 2-(3-thienyl)ethyl 9-dicyano methylenefluorene-4-carboxylate, 2-phenylthioethyl 9-dicyano methylenefluorene-4-carboxylate, 11,11,12,12-tetracyano anthraquino dimethane or 1,3-dimethyl-10-(dicyanomethylene)-anthrone, and the like; an imaging member further containing an adhesive layer and a hole blocking layer; an imaging member wherein the blocking layer is contained as a coating on a substrate and wherein the adhesive layer is coated on the blocking layer; and photoconductive imaging members comprised of an optional supporting substrate, a single layer comprised of a photogenerating layer of a metal free phthalocyanine, and further BZP perylene, which BZP is preferably comprised a mixture of bisbenzimidazo(2,1-a-1′,2′-b)anthra(2,1,9-def:6,5,10-d′e′f′)diisoquinoline-6,11-dione and bisbenzimidazo(2,1-a:2′,1′-a)anthra(2,1,9-def:6,5,10-d′e′f′)diisoquinoline-10,21-dione, reference U.S. Pat. No. 4,587,189, the disclosure of which is totally incorporated herein by reference, charge transport molecules, reference for example, U.S. Pat. No. 4,265,990, the disclosure of which is totally incorporated herein by reference, electron transport components, and a binder polymer. Preferably the charge transport molecules for the photogenerating mixture layer are aryl amines, and the electron transport is a fluorenylidene, such as (4-n-butoxycarbonyl-9-fluorenylidene)malononitrile, reference U.S. Pat. No. 4,474,865, the disclosure of which is totally incorporated herein by reference.

The positively charged, or negatively charged photoresponsive imaging member of the present invention in embodiments is comprised, in the following sequence, of a supporting substrate, a single layer thereover comprised of a photogenerator layer comprised of a metal free phthalocyanine, charge transport molecules of N,N′-diphenyl-N,N′-bis(3-methyl phenyl)-1,1′-biphenyl-4,4′-diamine, and electron transport components of (4-n-butoxycarbonyl-9-fluorenylidene) malononitrile all dispersed in a suitable polymer binder, such as a polycarbonate binder.

Examples of photogenerating components, especially pigments are metal free phthalocyanines, and as an optional second pigment metal phthalocyanines, perylenes, vanadyl phthalocyanine, chloroindium phthalocyanine, and benzimidazole perylene, which is preferably a mixture of, for example, 60/40, 50/50, 40/60, bisbenzimidazo(2,1-a-1′,2′-b)anthra(2,1,9-def:6,5,10-d′e′f′) diisoquinoline-6,11-dione and bisbenzimidazo(2,1-a:2′,1′-a)anthra(2,1,9-def:6,5,10-d′e′f′) diisoquinoline-10,21-dione, and the like, inclusive of appropriate known photogenerating components. The photogenerating component, which is preferably comprised of a metal free phthalocyanine, is in embodiments comprised of, for example, about 50 weight percent of the metal free and about 50 weight percent of a resin binder.

Charge transport components that may be selected for the photogenerating mixture include, for example, arylamines, and more specifically, N,N′-diphenyl-N,N-bis(3-methyl phenyl)-1,1′-biphenyl4,4′-diamine, 9-9-bis(2-cyanoethyl)-2,7-bis(phenyl-m-tolylamino)fluorene, tritolylamine, hydrazone, N,N′-bis(3,4 dimethylphenyl)-N″(1-biphenyl) amine and the like, dispersed in a polycarbonate binder.

Specific examples of electron transport molecules are (4-n-butoxycarbonyl-9-fluorenylidene)malononitrile, 2-methylthioethyl 9-dicyano methylenefluorene-4-carboxylate, 2-(3-thienyl)ethyl 9-dicyano methylenefluorene-4-carboxylate, 2-phenylthioethyl 9-dicyano methylenefluorene-4-carboxylate, 11,11,12,12-tetracyano anthraquino dimethane, 1,3-dimethyl-10-(dicyanomethylene)-anthrone, and the like.

The photogenerating pigment can be present in various amounts, such as, for example, from about 0.05 weight percent to about 30 weight percent, and more specifically, from about 0.05 weight percent to about 5 weight percent. Charge transport components, such as hole transport molecules, can be present in various effective amounts, such as in an amount of from about 10 weight percent to about 75 weight percent and preferably in an amount of from about 30 weight percent to about 50 weight percent; the electron transport molecule can be present in various amounts, such as in an amount of from about 10 weight percent to about 75 weight percent, and more specifically, in an amount of from about 5 weight percent to about 30 weight percent, and the polymer binder can be present in an amount of from about 10 weight percent to about 75 weight percent, and more specifically, in an amount of from about 30 weight percent to about 50 weight percent. The thickness of the single photogenerating layer can be, for example, from about 5 microns to about 60 microns, and more specifically, from about 10 microns to about 30 microns.

The photogenerating pigment primarily functions to absorb the incident radiation and generates electrons and holes. In a negatively charged imaging member, holes are transported to the photoconductive surface to neutralize negative charge and electrons are transported to the substrate to permit photodischarge. In a positively charged imaging member, electrons are transported to the surface where they neutralize the positive charges and holes are transported to the substrate to enable photodischarge. By selecting the appropriate amounts of charge and electron transport molecules, ambipolar transport can be obtained, that is, the imaging member can be charged negatively or positively charged, and the member can also be photodischarged.

The photoconductive imaging members can be prepared by a number of methods, such as the coating of the components from a dispersion, and more specifically, as illustrated herein. Thus, the photoresponsive imaging members of the present invention can in embodiments be prepared by a number of known methods, the process parameters being dependent, for example, on the member desired. The photogenerating, electron transport, and charge transport components of the imaging members can be coated as solutions or dispersions onto a selective substrate by the use of a spray coater, dip coater, extrusion coater, roller coater, wire-bar coater, slot coater, doctor blade coater, gravure coater, and the like, and dried at from about 40° C. to about 200° C. for a suitable period of time, such as from about 10 minutes to about 10 hours, under stationary conditions or in an air flow. The coating can be accomplished to provide a final coating thickness of from about 5 to about 40 microns after drying.

Imaging members of the present invention are useful in various electrostatographic imaging and printing systems, particularly those conventionally known as xerographic processes. Specifically, the imaging members of the present invention are useful in xerographic imaging processes wherein the photogenerating component absorbs light of a wavelength of from about 550 to about 950 nanometers, and preferably from about 700 to about 850 nanometers. Moreover, the imaging members of the present invention can be selected for electronic printing processes with gallium arsenide diode lasers, light emitting diode (LED) arrays which typically function at wavelengths of from about 660 to about 830 nanometers, and for color systems inclusive of color printers, such as those in communication with a computer. Thus, included within the scope of the present invention are methods of imaging and printing with the photoresponsive or photoconductive members illustrated herein. These methods generally involve the formation of an electrostatic latent image on the imaging member, followed by developing the image with a toner composition comprised, for example, of thermoplastic resin, colorant, such as pigment, charge additive, and surface additives, reference U.S. Pat. Nos. 4,560,635; 4,298,697 and 4,338,390, the disclosures of which are totally incorporated herein by reference, subsequently transferring the image to a suitable substrate, and permanently affixing, for example by heat, the image thereto. In those environments wherein the member is to be used in a printing mode, the imaging method is similar with the exception that the exposure step can be accomplished with a laser device or image bar.

The electron transport as indicated here is more specifically a tetra (t-butyl) diphenolquinone represented by the following formula

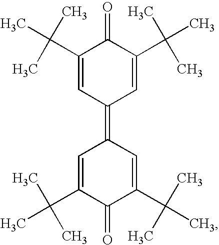

and

mixtures thereof, and (4-n-butoxycarbonyl-9-fluorenylidene)malononitrile of the following formulas

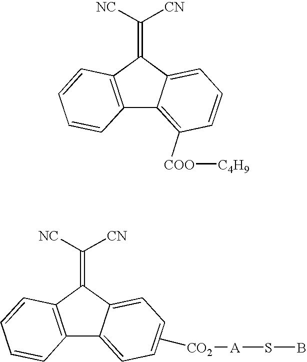

wherein S is sulfur, A is a spacer moiety or group selected from the group consisting of alkylene groups, wherein alkylene can contain, for example, from about 1 to about 14 carbon atoms, and arylene groups, which can contain from about 7 to about 36 carbon atoms, and B is selected from the group consisting of alkyl groups, and aryl groups. Specific examples include 2-methylthioethyl 9-dicyanomethylenefluorene-4-carboxylate, 2-(3-thienyl)ethyl 9-dicyano methylenefluorene-4-carboxylate, a 2-phenylthioethyl 9-dicyano methylenefluorene-4-carboxylate, and the like. The electron transporting materials can contribute to the ambipolar properties of the final photoreceptor and also provide the desired rheology and freedom from agglomeration during the preparation and application of the coating dispersion. Moreover, these electron transporting materials ensure substantial discharge of the photoreceptor during imagewise exposure to form the electrostatic latent image.

Polymer binder examples include components, as illustrated, for example, in U.S. Pat. No. 3,121,006, the disclosure of which is totally incorporated herein by reference. Specific examples of polymer binder materials include polycarbonates, acrylate polymers, vinyl polymers, cellulose polymers, polyesters, polysiloxanes, polyamides, polyurethanes and epoxies as well as block, random or alternating copolymers thereof. Preferred electrically inactive binders are comprised of polycarbonate resins with a molecular weight of from about 20,000 to about 100,000, and more specifically, with a molecular weight, M_{w} of from about 50,000 to about 100,000.

The combined weight of the arylamine hole transport molecules and the electron transport molecules in the electrophotographic photoconductive insulating layer is between about 35 percent and about 65 percent by weight, based on the total weight of the electrophotographic photoconductive insulating layer after drying. The film forming polymer binder can be present in an amount of from about 10 weight percent to about 75 weight percent, and preferably in an amount of from about 30 weight percent to about 60 weight percent, based on the total weight of the electrophotographic photoconductive insulating layer after drying. The hole transport and electron transport molecules are dissolved or molecularly dispersed in the film forming binder. The expression “molecularly dispersed”, as employed herein, is defined as dispersed on a molecular scale. The above materials can be processed into a dispersion useful for coating by any of the conventional methods used to prepare such materials. These methods include ball milling, media milling in both vertical or horizontal bead mills, paint shaking the materials with suitable grinding media, and the like to achieve a suitable dispersion.

The following Examples are provided.

The XRPDs were determined as indicated herein, that is X-ray powder diffraction traces (XRPDs) were generated on a Philips X-Ray Powder Diffractometer Model 1710 using X-radiation of CuK-alpha wavelength (0.1542 nanometer).

### EXAMPLE I

A pigment dispersion was prepared by roll milling 5 grams of x polymorph metal free phthalocyanine pigment particles and 5 grams of poly(4,4′-diphenyl-1,1′-cyclohexane carbonate) (PCZ400, binder available from Mitsubishi Gas Chemical Co., Inc.) in 65.8 grams of tetrahydrofuran (THF) with 400 grams of 3 millimeter diameter steel balls for ˜24 to 72 hours.

Separately, 18.8 grams of poly(4,4′-diphenyl-1,1′-cyclohexane carbonate) were weighed along with 12.2 grams of N,N′-diphenyl-N,N′-bis(methylphenyl)-1,1-biphenyl-4,4′-diamine, 8.2 grams of N,N′-bis(1,2-dimethylpropyl)-1,4,5,8-naphthalenetetracarboxylic diimide, 77.4 grams of THF and 22.1 grams of monochlorobenzene. This mixture was rolled in a glass bottle until the solids were dissolved, then 6.65 grams of the above pigment dispersion were added to form a dispersion containing the x polymorph of metal free phthalocyanine, poly(4,4-diphenyl-1,1′-cyclohexane carbonate), N,N′-diphenyl-N,N′-bis(methylphenyl)-1,1-biphenyl-4,4′-diamine, and N,N′-bis(1,2-dimethylpropyl)-1,4,5,8-naphthalenetetracarboxylic diimide in a solids weight ratio of (2:48:30:20) and a total solid contents of 27 percent; and rolled to mix (without milling beads). Various dispersions were prepared at total solids contents ranging from 25 percent to 28.5 percent. More than 26 dispersions were prepared at these ratios. These dispersions were applied by dip coating to aluminum drums having a length of 24 to 36 centimeters and a diameter of 30 millimeters. For the 27 weight percent dispersion, a pull rate of 100, 120, 140, and 160 millimeters/minute provided 20, 24, 30, and 36 micrometer thick single photoconductive insulating layers on the drums after drying. Thickness of the resulting dried layers were determined by capacitive measurement and by transmission electron microscopy.

### EXAMPLE II

A pigment dispersion was prepared by roll milling 6.3 grams of x polymorph metal free phthalocyanine pigment particles and 6.3 grams of poly(4,4′-diphenyl-1,1′-cyclohexane carbonate) binder (PCZ500, available from Teijin Chemical, Ltd.) in 107.4 grams of tetrahydrofuran (THF) with several hundred, about 700 to 800 grams, of 3 millimeter diameter steel or yttrium zirconium balls for about 24 to 72 hours.

Separately, 31.32 grams of poly(4,4′-diphenyl-1,1′-cyclohexane carbonate) were weighed with 20.25 grams of N,N′-diphenyl-N,N′-bis(methylphenyl)-1,1-biphenyl-4,4′-diamine, 13.50 grams of N,N′-bis(1,2-dimethylpropyl)-1,4,5,8-naphthalenetetracarboxylic diimide, 165.29 grams of THF, and 46.50 grams of monochlorobenzene. This mixture was rolled in a glass bottle until the solids were dissolved; then 23.14 grams of the above pigment dispersion were added to form a dispersion containing the x polymorph of metal free phthalocyanine, poly(4,4′-diphenyl-1,1′-cyclohexane carbonate), N,N′-diphenyl-N,N′-bis(methylphenyl)-1,1-biphenyl-4,4′-diamine, and N,N′-bis(1,2-dimethylpropyl)-1,4,5,8-naphthalenetetracarboxylic diimide in a solids weight ratio of (2:48:30:20) and a total solid contents of 22.5 percent; and rolled to further mix (without milling beads). Various dispersions were prepared at total solids content ranging from 20.5 percent to 23.5 percent. These dispersions were applied by dip coating to aluminum drums having a length of 24 to 36 centimeters and a diameter of 30 millimeters. For the 22.5 weight percent dispersion, a pull rate of 100, 120, 140, and 160 millimeters/minute provided 20, 24, 30, and 36 micrometer thick single photoconductive insulating layers on the drums after drying. Thickness of the resulting dried layers were determined by capacitive measurement and by transmission electron microscopy.

### EXAMPLE III

The above devices were electrically tested with a cyclic scanner set to obtain 100 charge-erase cycles immediately followed by an additional 100 cycles, sequences at 2 charge-erase cycles and 1 charge-expose-erase cycle, wherein the light intensity was incrementally increased with cycling to produce a photoinduced discharge curve from which the photosensitivity was measured. The scanner was equipped with a single wire corotron (5 centimeters wide) set to deposit 100 nanocoulombs/cm² of charge on the surface of the drum devices. The devices of Examples I and II were first tested in the positive charging mode and then in the negative charging mode. The exposure light intensity was incrementally increased by means of regulating a series of neutral density filters, and the exposure wavelength was controlled by a bandfilter at 780+ or −5 nanometers. The exposure light source was 1,000 watt Xenon arc lamp white light source.

The drum was rotated at a speed of 20 rpm to produce a surface speed of 8.3 inches/second or a cycle time of three seconds. The entire xerographic simulation was carried out in an environmentally controlled light tight chamber at ambient conditions (35 percent RH and 20° C.).

Photoinduced discharge characteristics (PIDC) curves at positive and negative charging modes of a 30 micrometer thick drum of Example I showed initial photosensitivities, dV/dX, of ˜200 and 120 Vcm²/ergs for positive and negative charging modes, respectively. The devices exhibited an E_{1/2} of 3 ergs/cm² (a ten-fold improvement in contrast to an E_{1/2} of 12.4 ergs/cm² as shown in Example IV of U.S. Ser. No. 09/302,524), and 2.2 ergs/cm² for positive and negative charging modes, respectively.

### EXAMPLE IV

Photoinduced discharge characteristics (PIDC) curves at positive and negative charging modes of a 30 micrometer thick photoconductive drum of Example II show initial photosensitivities, dV/dX, of ˜200 and 120 Vcm²/ergs for positive and negative charging modes, respectively. The devices exhibited an E_{1/2} of 3.1 ergs/cm² (a ten-fold improvement in contrast to a E_{1/2} of 12.4 ergs/cm² as shown in Example IV of U.S. Ser. No. 09/302,524), and 2.2 ergs/cm² for a positive and negative charging modes, respectively.

### EXAMPLE V

The processes of Example I were repeated except that 1,1′-dioxo-2-(4-methylphenyl)-6-phenyl-4-(dicyanomethylidene) thiopyran, an electron transport molecule, was substituted for N,N′-bis(1,2-dimethylpropyl)-1,4,5,8-naphthalenetetracarboxylic diimide. The resulting single layer coating was applied to an aluminum drum as described in Example I. The resulting drum, after drying, was less sensitive than the drums described in Examples III and IV.

### EXAMPLE VI

The processes of Example I were repeated except that carboxybenzylnaphthaquinone, an electron transport molecule, was substituted for N,N′-bis(1,2-dimethylpropyl)-1,4,5,8-naphthalene tetracarboxylic diimide. This coating was applied to an aluminum drum as described in Example I. The resulting drum, after drying, was less sensitive than the drums described in Examples III and IV.

### EXAMPLE VII

The processes of Example I were repeated except that a mixture of carboxybenzylnaphthaquinone and tetra(t-butyl) diphenolquinone at a ratio of 7 to 1 by weight was substituted for N,N′-bis(1,2-dimethylpropyl)-1,4,5,8-naphthalenetetracarboxylic diimide. This coating was applied to an aluminum drum as described in Example I. The resulting drum, after drying, was less sensitive than the drums described in Examples III and IV.

### EXAMPLE VIII

Photoreceptor devices were prepared on aluminum pipes with a 3 micrometer thick undercoat layer comprised of titanium dioxide particles in a phenolic resin binder and a 24 micrometer thick electrophotographic photosensitive layer coated from a 27 weight percent dispersion as in Example I. The typical dark decay of the drum devices in negative charging mode was 48 V/s, in contrast to value as high as 140 V/s for devices without the undercoat layer. The device shows improvement in dark decay properties without significant degradation of photosensitivity when imaged in the negative charging mode.

### EXAMPLE IX

Type x polymorph metal free phthalocyanine as prepared in Example III was utilized as the photogenerating pigment in an imaging member prepared by the following procedure. A titanized MYLAR® (polyethylene terephthalate) substrate, 75 microns in thickness throughout, was coated with a blocking layer of a silane/zirconium alkoxide solution prepared by mixing 6.5 grams of acetylacetonate tributoxy zirconium, 0.75 gram of (aminopropyl)trimethoxysilane, 28.5 grams of isopropyl alcohol and 14.25 grams of butanol using a wire rod applicator. The blocking layer was dried at 140° C. for 20 minutes, and the final thickness thereof was measured to be 0.1 micron. An adhesive layer of polyester resin (MOR-ESTER 49,000, available from Norton International) was prepared by dissolving 0.5 gram of the polyester resin in 70 grams of tetrahydrofuran and 29.5 grams of cyclohexanone. The resulting solution was coated with a 0.5 mil film coating applicator and dried at 100° C. for 10 minutes to a final dry thickness of 0.05 micron. The polyester adhesive layer was coated with a single layer of a mixture of a photogenerating pigment, hole transport molecules, electron transport, and a polymer binder as follows. There was prepared with a paint shaker (2 hours of shaking) a dispersion of 0.5 gram of hydroxy gallium phthalocyanine Type V in 0.263 gram of the block copolymer of styrene/4-vinyl pyridine in 17.4 grams of toluene dispersed with 70 grams of glass beads (about 0.8 millimeter). A formulation of 0.2 gram of the resulting dispersion, 1 gram of the hole transport molecule N,N′-diphenyl-N,N′-bis(3-methyl phenyl)-1,1′-biphenyl4,4-diamine, and 0.2 gram of the electron transport component (4-n-butoxycarbonyl-9-fluorenylidene)malononitrile, 2.1 grams of polycarbonate binder (available as MAKROLON™ 5705 from Bayer A.G.) and 16.5 grams of dichloromethane were prepared. The resulting solution was coated on the above adhesive layer contained on the titanized MYLAR® substrate with a 10 mil film coating applicator and dried at 115° C. for 60 minutes to result in a thickness for the single layer of about 25 microns.

The xerographic electrical properties of the above prepared photoconductive imaging member and other similar members can be determined by known means, including electrostatically charging the surfaces thereof with a corona discharge source until the surface potentials, as measured by a capacitively coupled probe attached to an electrometer, attained an initial value Vₒ of about −800 volts. After resting for 0.5 second in the dark, the charged members attained a surface potential of V_{ddp}, dark development potential. Each member was then exposed to light from a filtered Xenon lamp thereby inducing a photodischarge which resulted in a reduction of surface potential to a V_{bg} value, background potential. The percent of photodischarge was calculated as 100×(V_{ddp}−V_{bg})V_{ddp}. The desired wavelength and energy of the exposed light was determined by the type of filters placed in front of the lamp. The monochromatic light photosensitivity was determined using a narrow band-pass filter. The photosensitivity of the imaging member was usually provided in terms of the amount of exposure energy in ergs/cm², designated as E_{1/2}, required to achieve 50 percent photodischarge from V_{ddp} to half of its initial value. The higher the photosensitivity, the smaller is the E_{1/2} value. The device was finally exposed to an erase lamp of appropriate light intensity and any residual potential (V_{residual}) was measured. The imaging members were tested with an exposure monochromatic light at a wavelength of 800 nanometers and an erase broad-band light with the wavelength of about 400 to about 800 nanometers. The imaging members were cycled continuously for 10,000 cycles of charge, exposed and erased, and changes in V_{ddp} and V_{residual} were measured. The imaging member could be charged both negatively and positively and photodischarged.

The imaging member fabricated as in Example IV had a dark decay of 26 volts/second, and the V_{residual} was 63 volts for negative charging, and this member had a dark decay of 102 volts/second, E_{1/2} of 12.4 ergs/cm² and the V_{residual} was 92 volts for a positively charged member.

### EXAMPLE X

A photoconducting imaging member was prepared following the processes as described in Example IV. A formulation of 0.4 gram of the dispersion prepared, 1 gram of N,N′-diphenyl-N,N′-bis(3-methyl phenyl)-1,1′-biphenyl-4,4′-diamine, 0.2 gram of (4-n-butoxycarbonyl-9-fluorenylidene)malononitrile, 1.9 grams of polycarbonate binder (available as MAKROLON™ 5705 from Bayer A.G.) and 16.5 grams of dichloromethane was generated. The resulting solution was then coated on the adhesive layer of the titanized substrate as described in Example IV with a 10 mil film coating applicator and dried at 115° C. for 60 minutes to result in a thickness for the single layer with the above photogenerating pigment, charge transport molecule and electron transport compound of about 25 microns.

The imaging member fabricated in Example V had a dark decay of 30 volts/second, E_{1/2} of 10.3 ergs/cm² and V_{residual} of 41 volts for negative charging (the member was negatively charged by a corona wires) and had a dark decay of 106 volts/second, E_{1/2} of 6.4 ergs/cm² and the V_{residual} was 69 volts for positive charging.

### EXAMPLE XI

A photoconducting imaging member was prepared following the processes as described in Example IV. A formulation of 1 gram of the dispersion thus prepared, 1.2 grams of N,N′-diphenyl-N,N′-bis(3-methyl phenyl)-1,1′-biphenyl-4,4′-diamine, 0.4 gram of (4-n-butoxycarbonyl-9-fluorenylidene)malononitrile, 1.7 grams of polycarbonate binder (available as MAKROLON™ 5705 from Bayer A.G.) and 20 grams of dichloromethane was prepared. The resulting solution was coated on the adhesive layer of the titanized substrate as described in Example IV with a 10 mil film coating applicator and dried at 115° C. for 60 minutes to result in a thickness of about 25 microns.

The imaging member fabricated in Example VI possessed a dark decay of 32 volts/second, E₁₂ of 5.5 ergs/cm² and a V_{residual} of 18 volts for negative charging and had a dark decay of 76 volts/second, E_{1/2} of 2.8 ergs/cm² and V_{residual} of 30 volts for positive charging. Xerographic cycling tests accomplished as described in Example IV for 10,000 cycles for the above prepared negatively charged imaging members indicated cycle-down of about 110 volts and a cycle-up of 18 volts, an improvement over the same member with instead a vanadyl phthalocyanine photogenerating pigment.

### EXAMPLE XII

A photoconducting imaging member was prepared following the procedures as described in Example IV except, for example, that the single layer coating was coated on an aluminized MYLAR® substrate. A formulation of 1.5 grams of the dispersion thus prepared, 1.2 grams of N,N′-diphenyl-N,N′-bis(3-methyl phenyl)-1,1′-biphenyl-4,4′-diamine, 0.4 gram of (4-n-butoxycarbonyl-9-fluorenylidene)malononitrile, 1.7 grams of polycarbonate (PC(Z)) and 17.3 grams of monochlorobenzene was generated. The solution was then coated with a 10 mil film coating applicator on the aluminized MYLAR® substrate, which substrate was of a thickness of about 75 microns, throughout the Examples, and dried at 115° C. for 60 minutes to result in a thickness for the entire photoconductive member of about 103 microns with the single layer thereover being of a thickness of about 28 microns.

The imaging member fabricated as in Example VII had a dark decay of 29 volts/second, E_{1/2} of 4.8 ergs/cm² and V_{residual} of 18 volts for negative charging and had a dark decay of 46 volts/second, E_{1/2} of 3 ergs/cm² and V_{residual} of 38 volts for positive charging.

Other embodiments and modifications of the present invention may occur to those skilled in the art subsequent to a review of the information presented herein; these embodiments and modifications, equivalents thereof, substantial equivalents thereof, or similar equivalents thereof are also included within the scope of this invention.

What is claimed is:

1. A photoconductive imaging member comprised of a supporting substrate, and thereover a single layer comprised of a mixture of a photogenerator component, a charge transport component, an electron transport component, and a polymer binder, and wherein the photogenerating component is a metal free phthalocyanine.

2. An imaging member in accordance with claim 1 wherein said single layer is of a thickness of from about 5 to about 60 microns.

3. An imaging member in accordance with claim 1 wherein the amounts for each of said components in said single layer is from about 0.05 weight percent to about 30 weight percent for the photogenerating component, from about 10 weight percent to about 75 weight percent for the charge transport component, and from about 10 weight percent to about 75 weight percent for the electron transport component, and wherein the total of said components is about 100 percent, and wherein said layer components are dispersed in from about 10 weight percent to about 75 weight percent of said polymer binder, and wherein said layer is of a thickness of from about 5 to about 15 microns.

4. An imaging member in accordance with claim 1 wherein the amounts for each of said components in the single layer mixture is from about 0.5 weight percent to about 5 weight percent for the photogenerating component; from about 30 weight percent to about 50 weight percent for the charge transport component; and from about 5 weight percent to about 30 weight percent for the electron transport component; and which components are contained in from about 30 weight percent to about 50 weight percent of a polymer binder.

5. An imaging member in accordance with claim 1 wherein the thickness of said layer is from about 5 to about 35 microns.

6. An imaging member in accordance with claim 1 wherein said single layer components are dispersed in said polymer binder, and wherein said charge transport is comprised of hole transport molecules.

7. An imaging member in accordance with claim 6 wherein said binder is present in an amount of from about 50 to about 90 percent by weight, and wherein the total of all components of said photogenerating component, said charge transport component, said binder, and said electron transport component is about 100 percent.

8. An imaging member in accordance with claim 1 wherein said photogenerating component absorbs light of a wavelength of from about 370 to about 950 nanometers.

9. An imaging member in accordance with claim 1 wherein the supporting substrate is comprised of a conductive substrate comprised of a metal.

10. An imaging member in accordance with claim 9 wherein the conductive substrate is aluminum, aluminized polyethylene terephthalate or titanized polyethylene terephthalate.

11. An imaging member in accordance with claim 6 wherein the binder is selected from the group consisting of polyesters, polyvinyl butyrals, polycarbonates, polystyrene-b-polyvinyl pyridine, and polyvinyl formulas.

12. An imaging member in accordance with claim 1 wherein said charge transport component comprises aryl amine molecules.

13. An imaging member in accordance with claim 1 wherein said charge transporting component or components is comprised of molecules of the formula 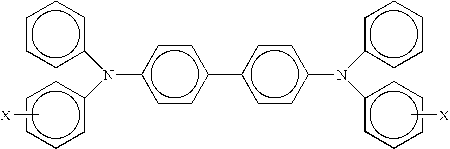
wherein X is selected from the group consisting of alkyl and halogen.

14. An imaging member in accordance with claim 13 wherein alkyl contains from about 1 to about 10 carbon atoms, and wherein the charge transport is an aryl amine encompassed by said formula and which amine is optionally dispersed in a resinous binder.

15. An imaging member in accordance with claim 13 wherein alkyl contains from 1 to about 5 carbon atoms.

16. An imaging member in accordance with claim 13 wherein alkyl is methyl, and wherein halogen is chloride.

17. An imaging member in accordance with claim 13 wherein said charge transport is comprised of molecules of N,N′-diphenyl-N,N-bis(3-methyl phenyl)-1,1′-biphenyl4,4′-diamine.

18. An imaging member in accordance with claim 1 wherein said electron transport component is (4-n-butoxycarbonyl-9-fluorenylidene) malononitrile, 2-methylthioethyl 9-dicyanomethylenefluorene-4-carboxylate, 2-(3-thienyl)ethyl 9-dicyanomethylene fluorene-4-carboxylate, 2-phenylthioethyl 9-dicyanomethylenefluorene-4-carboxylate, 11,11,12,12-tetracyano anthraquinodimethane or 1,3-dimethyl-10-(dicyanomethylene)-anthrone.

19. An imaging member in accordance with claim 1 wherein said electron transport component is (4-n-butoxycarbonyl-9-fluorenylidene)malononitrile.

20. An imaging member in accordance with claim 13 wherein said electron transport component is (4-n-butoxycarbonyl-9-fluorenylidene)malononitrile, 2-methylthioethyl 9-dicyanomethylenefluorene-4-carboxylate, 2-(3-thienyl)ethyl 9-dicyanomethylenefluorene-4-carboxylate, 2-phenylthioethyl 9-dicyanomethylenefluorene-4-carboxylate, 11,11,12,12-tetracyano anthraquinodimethane or 1,3-dimethyl-10-(dicyanomethylene)-anthrone.

21. An imaging member in accordance with claim 1 further including a second photogenerating component of a titanyl phthalocyanine, a metal phthalocyanine other than titanyl phthalocyanine, a perylene, trigonal selenium, or mixtures thereof.

22. An imaging member in accordance with claim 1 wherein said electron transport is (4-n-butoxy carbonyl-9-fluorenylidene)malononitrile, and the charge transport is a hole transport of N,N′-diphenyl-N,N-bis(3-methyl phenyl)-1,1′-biphenyl4,4″-diamine molecules.

23. An imaging member in accordance with claim 1 wherein said phthalocyanine has major peaks, as measured with an X-ray diffractometer, at Bragg angles (2 theta±0.2).

24. A photoconductive imaging member comprised of a mixture containing a photogenerating component, hole transport molecules and an electron transport component, and thereover and in contact with said first layer a second layer comprised of hole transport molecules dispersed in a resin binder.

25. A method of imaging which comprises generating an electrostatic latent image on the imaging member of claim 1, developing the latent image, and transferring the developed electrostatic image to a suitable substrate.

26. An imaging member in accordance with claim 24 wherein said electron transport is (4-n-butoxycarbonyl-9-fluorenylidene)malononitrile, 2-methylthioethyl 9-dicyanomethylenefluorene-4-carboxylate.

27. An imaging member in accordance with claim 1 further containing an adhesive layer and a hole blocking layer.

28. An imaging member in accordance with claim 27 wherein said blocking layer is contained as a coating on a substrate, and wherein said adhesive layer is coated on said blocking layer.

29. An imaging member in accordance with claim 1 wherein said member comprises, in sequence, a supporting layer, and a single electrophotographic photoconductive insulating layer, the electrophotographic photoconductive insulating layer comprising particles comprising a metal free phthalocyanine photogenerating pigment dispersed in a matrix comprising an arylamine hole transporter, and an electron transporter selected from the group consisting of N,N′-bis(1,2-dimethylpropyl)-1,4,5,8-naphthalenetetracarboxylic diimide represented by the formula 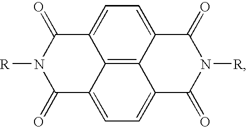
1,1′-dioxo-2-(4-methylphenyl)-6-phenyl-4-(dicyanomethylidene) thiopyran represented by the following structural formula 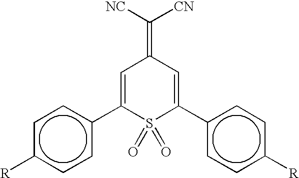
wherein R is independently selected from the group consisting of hydrogen, alkyl with 1 to about 4 carbon atoms, alkoxy with 1 to about 4 carbon atoms and halogen, and a quinone selected from the group consisting of carboxybenzylnaphthaquinone represented by the formula 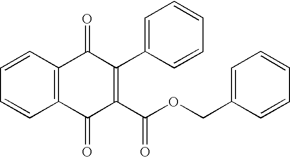
and
tetra(t-butyl) diphenolquinone represented by the following structural formula 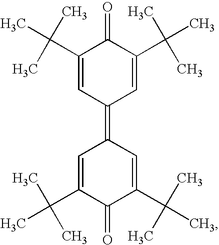
and
mixtures thereof; and said binder is a film forming binder.

30. An imaging member in accordance with claim 29 wherein the arylamine is N,N′-diphenyl-N,N′-bis(3-methylphenyl)-[1,1′-biphenyl]-4,4′-diamine.

31. An imaging member in accordance with claim 29 wherein the film forming binder is a polycarbonate.

32. An imaging member in accordance with claim 29 wherein the electrophotographic photoconductive insulating layer has a thickness of from about 4 micrometers to about 50 micrometers after drying.

33. An imaging member in accordance with claim 1 wherein the electrophotographic photoconductive insulating layer has a thickness of from about 5 micrometers to about 30 micrometers after drying, wherein the member is free of a charge blocking layer between the supporting layer and the single layer, and wherein the member is free of any anti-plywood layer between the supporting layer and the single layer.

34. An imaging member in accordance with claim 1 wherein the single layer components are dispersed in a binder selected from the group consisting of polycarbonates, polystyrene-b-polyvinyl pyridine, N,N′-diphenyl-N,N′-bis(alkylphenyl)-1,1-biphenyl-4,4′-diamine; TTA, tri-p-tolylamine; AE-18, N,N′-bis-(3,4,-dimethylphenyl)-4-biphenyl amine; AB-16, N,N′-bis-(4-methylphenyl)-N,N″-bis(4-ethylphenyl)-1,1′-3,3′-dimethylbiphenyl)-4,4′-diamine; and PHN, phenanthrene diamine; and wherein the charge transport comprises aryl amine molecules of the formula 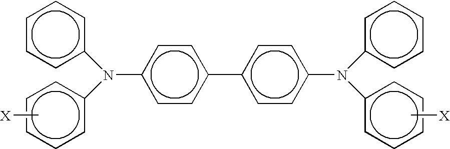
wherein X is selected from the group consisting of alkyl and halogen.

35. A photoconductive imaging member comprised of a supporting substrate, and thereover a single layer comprised of a mixture of a photogenerator component, a charge transport component, an electron transport component, and a polymer binder, and wherein the photogenerating component is selected from the group consisting of a metal free phthalocyanine and a perylene.
